(19) United States
(12) Patent Application Publication
(10) Pub. No.: US 2008/0147973 A1
(43) Pub. Date: Jun. 19, 2008

(54) Provisioning storage

(76) Inventors: Brian R. Gruttadauria, Sutton, MA (US); Brian Foster, Haverhill, MA (US); Michael S. Ryan, Woodinville, WA (US); Joseph Frank, Boulder, CO (US)

Correspondence Address: RICHARD M. SHARKANSKY, PO BOX 557, MASHPEE, MA, 02649, US

(21) Appl. No.: 11/641,148

(22) Filed: Dec. 19, 2006

(51) Int. Cl. G06F 12/00

(52) U.S. Cl. 711/114; 711/E12.001

(57) ABSTRACT

Storage is provisioned. By a user interface hosted at a storage system, a user is allowed to affect a set of storage system configuration settings residing on the storage system. The set of storage system configuration settings has options for different levels of redundant array of independent disks (RAID) data protection. Based on the set of storage system configuration settings, the storage system is configured for RAID data protection.

### FIELD OF THE INVENTION

The present invention relates generally to provisioning storage.

### BACKGROUND OF THE INVENTION

As the need for reliable storage solutions increases, computer storage providers have been designing solutions that incorporate one or more redundant array of inexpensive disks (RAIDs). RAID is a storage technology wherein a collection of multiple disk drives is organized into a disk array managed by a common array controller. The array controller presents the array to the user as one or more virtual disks. Disk arrays are the framework to which RAID functionality is added in functional levels to produce cost-effective, highly available, high-performance disk systems.

Although RAID provides the reliability users are looking for, setting up a disk array to work in accordance with a given RAID level is not always straight forward for a user. For instance, RAID level 0 is a performance-oriented striped data mapping technique. Uniformly sized blocks of storage are assigned in a regular sequence to all of the disks in the array. RAID 0 provides high I/O performance at low cost. Reliability of a RAID 0 system is less than that of a single disk drive because failure of any one of the drives in the array can result in a loss of data.

RAID level 1, also called mirroring, provides simplicity and a high level of data availability. A mirrored array includes two or more disks wherein each disk contains an identical image of the data. A RAID level 1 array may use parallel access for high data transfer rates when reading. RAID 1 provides good data reliability and improves performance for read-intensive applications, but at a relatively high cost.

RAID level 2 is a parallel mapping and protection technique that employs error correction codes (ECC) as a correction scheme, but is sometimes considered unnecessary because off-the-shelf drives come with ECC data protection.

RAID level 3 adds redundant information in the form of parity data to a parallel accessed striped array, permitting regeneration and rebuilding of lost data in the event of a single-disk failure. One stripe unit of parity protects corresponding stripe units of data on the remaining disks. RAID 3 provides high data transfer rates and high data availability. Moreover, the cost of RAID 3 is lower than the cost of mirroring since there is less redundancy in the stored data.

RAID level 4 uses parity concentrated on a single disk to allow error correction in the event of a single drive failure (as in RAID 3). Unlike RAID 3, however, member disks in a RAID 4 array are independently accessible. Thus RAID 4 is sometimes more suited to transaction processing environments involving short file transfers. RAID 4 and RAID 3 both have a write bottleneck associated with the parity disk, because every write operation modifies the parity disk.

In RAID 5, parity data is distributed across some or all of the member disks in the array. Thus, the RAID 5 architecture achieves performance by striping data blocks among N disks, and achieves fault-tolerance by using 1/N of its storage for parity blocks, calculated by taking the exclusive-or (XOR) results of all data blocks in the parity disks row. The write bottleneck is reduced because parity write operations are distributed across multiple disks.

The RAID 6 architecture is similar to RAID 5, but RAID 6 can overcome the failure of any two disks by using an additional parity block for each row (for a storage loss of 2/N). The first parity block (P) is calculated with XOR of the data blocks. The second parity block (Q) employs Reed-Solomon codes.

The RAID 0 mentioned above is advantageous in supporting high I/O performance, and the RAID 1, RAID 3, and RAID 5 are advantageous in supporting fault tolerance and data rebuild. If a combination of RAID storing types RAID 0+RAID 1 (represented as RAID 10) is used, both advantages are achieved. Of course, other combinations such as RAID 0+RAID 3 (represented as RAID 30) or RAID 0+RAID 5 (represented as RAID 50) are also valid.

As can be appreciated, even the most knowledgeable computer administrators are required to have a good working understanding of RAID and the ability to select the correct hardware to make the storage solution work. To facilitate this, some companies provide preconfigured RAID arrays, which can be connected to a computer system, such as a server computer or a cluster. Although these RAID solutions provide good data storage reliability, a computer technician/administrator is typically required to initially configure the RAID solution on a system.

### SUMMARY OF THE INVENTION

Storage is provisioned. By a user interface hosted at a storage system, a user is allowed to affect a set of storage system configuration settings residing on the storage system. The set of storage system configuration settings has options for different levels of redundant array of independent disks (RAID) data protection. Based on the set of storage system configuration settings, the storage system is configured for RAID data protection.

One or more implementations of the invention may provide one or more of the following advantages.

Service costs associated with the setup and configuration of a small office/home office storage system can be reduced. A new level of ease-of-use can be employed in allowing for immediate access to the storage of a storage system.

Other advantages and features will become apparent from the following description, including the drawings, and from the claims.

### BRIEF DESCRIPTION OF THE DRAWINGS

FIG. 1 is a block diagram of a data storage system.

FIG. 2 is a flow diagram of a procedure for use with the data storage system of FIG. 1.

FIGS. 3A-3C are illustrations of an example of a drive configuration definition for use with the data storage system of FIG. 1.

### DETAILED DESCRIPTION

Data storage devices have a wide range of uses. For each use, the user of the device or manufacturer must define a configuration compatible for the planned use. Configuration of storage devices conventionally requires expert knowledge of the applications to be run and the type of storage available. For some conventional devices, the user either uses a fixed preconfigured device or needs to be trained to configure a RAID implementation and provision the device.

Conventionally, the process of provisioning a storage device requires several complicated manual procedures which a customer or service engineer must perform to complete the task, and customers can make mistakes and may not know the correct options to select, e.g., when configuring a small office/home office (SOHO) storage device having multiple disk drives. In accordance with the provisioning technique described herein, the process of provisioning the storage array is automated, based on a defined set of XML procedure files that take into account the number of drives and the eventual usage of the storage device.

In particular, conventionally a customer or original equipment manufacturer (OEM) was required to manually configure the disks and create the RAID partitions of a storage device prior to mounting the first file system to store data. In accordance with the provisioning technique described herein, a new level of ease-of-use is provided in allowing for immediate access to the storage of a storage device; the storage device automatically provisions the storage based on a configurable policy file, creates the appropriate file system, and makes the storage accessible from a network attached computer. The provisioning technique also helps eliminate manual misconfigurations that could cause problems and lead to service calls.

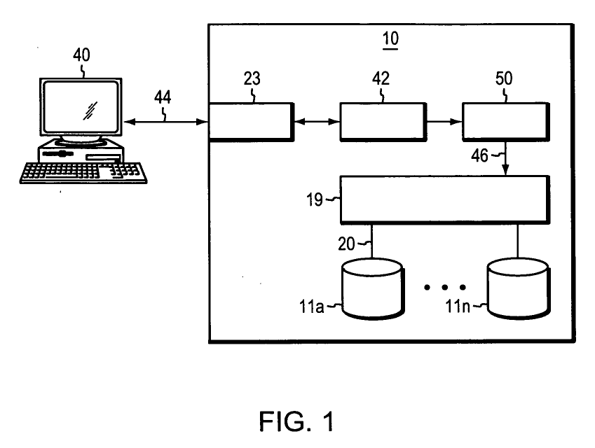

FIG. 1 shows a block diagram of an illustrative data storage system 10 for use in implementing provisioning storage according to the present invention. The data storage system 10 includes a number of data storage devices 11a . . . 11n and a storage system controller 19 driving the data storage devices via connections 20. Typically the data storage devices are disk storage devices, each of which may include one or more disk drives, dependent upon the user's requirements and system configuration. However, the data storage system 10 may use other kinds of storage devices, including but not limited to optical disks, CD ROMS and magnetic tape devices.

System 10 provides a user interface 23 accessible over a connection 44 (e.g., a network connection) by a computing device 40 (e.g., a computer running a Web browser). As described below, at least one configuration file 42 is affected by user interface 23, and a drive manager 50 drives controller 19 based on the contents of the file 42.

The technique allows the user flexibility in configuring system 10. The user interacts with interface 23 to configure the storage system. The interface displays several different configuration options and general descriptions for those options. Using the interface, the user can read the descriptions of the configurations and choose the option best suited to the user's storage needs. This gives a user, who may be a lay person with respect to the installation and configuration of storage systems, the ability to simply choose between multiple pre-configured systems based on a usage description. Following the user selection of the configuration, the associated configuration file 42 is loaded and used by drive manager 50 and controller 19 to configure system 10.

The technique is made possible by abstracting the configuration settings for the storage system outside the drive manager into one or more easily changeable configuration files. That is, configuration settings for the system are not “hard coded” into the drive manager but are loaded from file 42 when the drive manager executes to drive controller 19 to provision devices 11a . . . 11n. This enables multiple different RAID configuration descriptions to be loaded and the appropriate configuration selected and implemented on the system.

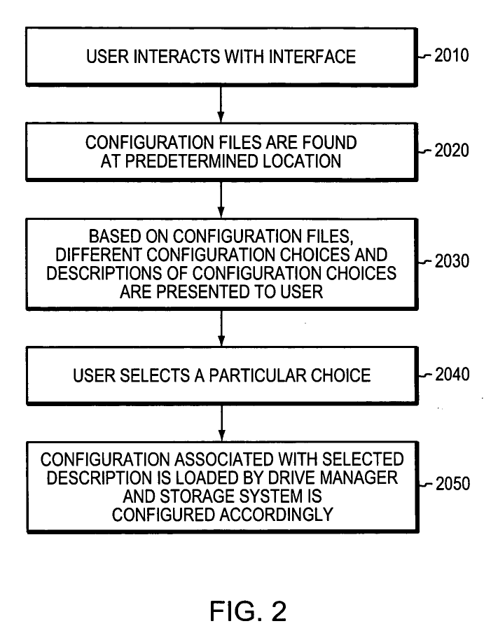

The program flow of an embodiment example embodiment is as follows (FIG. 2):

1) The user interacts with interface 23 (step 2010)

2) One or more configuration files 42 are found at a predetermined location (step 2020)

3) Based on the configuration files, different configuration choices and a descriptions of configuration choices are presented to the user (step 2030)

4) The user selects a particular choice (step 2040)

5) The configuration associated with the selected description is loaded by drive manager 50 and the storage system is configured accordingly (step 2050)

Not embedding the configuration settings in the drive manager software code allows the technique to offer the user a set of easily edited and/or pre-bottled configurations for use of the storage system. The descriptions of the user selections are such that this feature may be used by a lay person. The descriptions provide a simple description of the tradeoffs between the choices including which option is better for which applications (email server, file server, etc.).

The technique also allows OEM suppliers to add or modify the user selectable options provided. Other embodiments support multiple RAID sets.

In at least some implementations, files 42 of the XML type are used to describe the RAID configurations, and interface 23 is a Web-based tool.

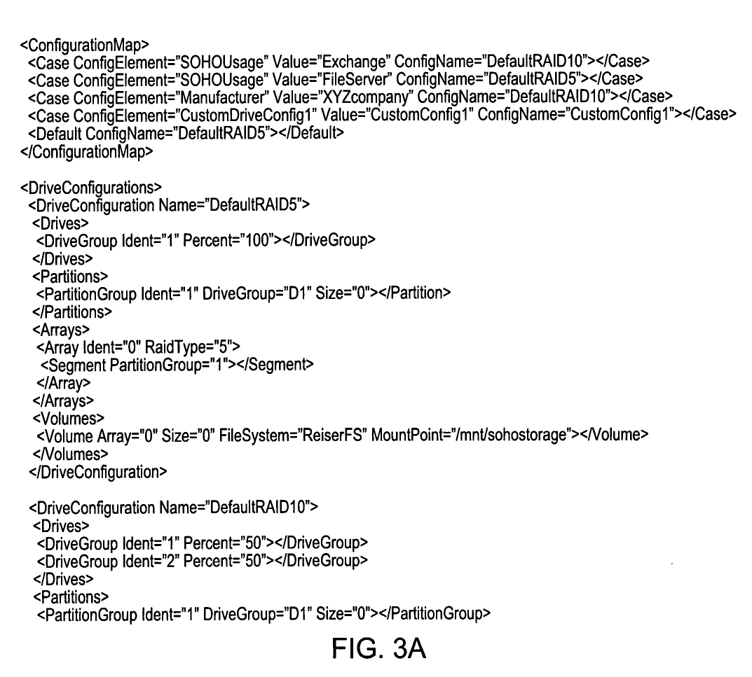

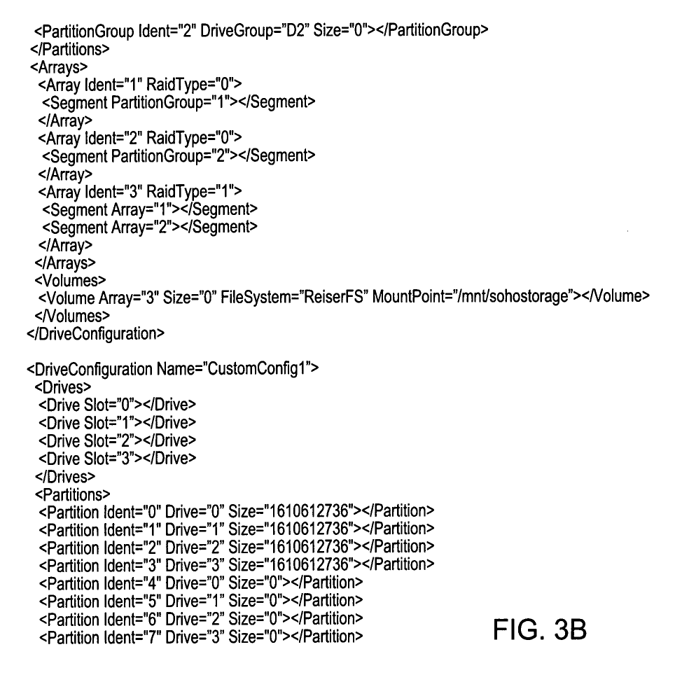

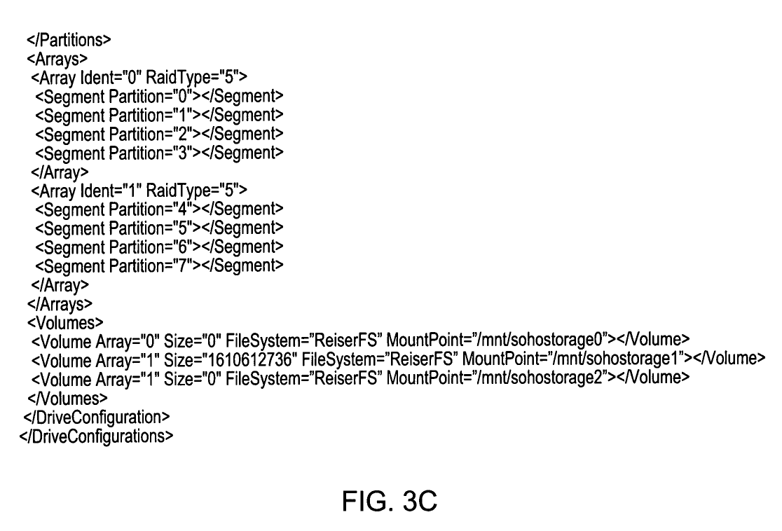

FIG. 3 illustrates an example of a default drive configuration XML definition as included in a sample file 42. The example includes a description and sample array configuration file meant to define the XML layout and the capabilities of the array configuration file.

In system 10 the file exists as /etc/drivemanager/driveconfig.xml, and in at least some implementations may be distributed only with a jffs2 image that is mounted on /etc. Drive manager 50 is the only controller-driving component of system 50 that accesses this file.

The file includes two sections: the “ConfigurationMap” configuration map section and the “DriveConfigurations” drive configurations section. The configuration map section defines rules used to decide which default drive configuration to use. The drive configuration section defines the default drive configurations. A default drive configuration is built by the drive manager any time an event is received that results in a full complement of clean drives.

The ConfigurationMap section contains 1 or more “Case” elements and a “Default” element. Each case element has attributes “ConfigElement”, “Value”, and “ConfigName”. Drive manager uses the “ConfigElement” attribute to identify and locate an element in a master configuration file. Drive manager then tries to match the value attribute of this case element with the value attribute of the element in the master configuration file. Example: <SOHOUsage Value=“FileServer”></SOHOUsage>. If a match is found, “ConfigName” is used to identify the configuration to use in the “DriveConfiguration” section. All following case elements are ignored. If no case statement results in a match, “ConfigName” attribute in the “Default” element is used to define the default configuration. Case elements can be either statically defined at ship time, or can be created and deleted by the drive manager in response to commands or events.

The “DriveConfigurations” section contains one or more “DriveConfiguration” elements that define a default configuration. A drive configuration element has a “Name” attribute and 4 sections: Drives, Partitions, Arrays, and Volumes.

The “Drives” section contains either “Drive” elements, or “DriveGroup” elements (not both). A drive element has the “Slot” attribute that identifies the drive in a specific slot. The drive group elements has attributes “Ident” and “Percent”. Group “ident” identifies the group, “Percent” is the percentage of the total drives in the device that are in the drive group. Drive manager truncates drive fractions.

The “Partitions” section contains either “Partition” or “PartitionGroup” elements (not both). Partition elements have a “Drive” attribute that identifies the drive on which to create the partition. Partition group elements have a “DriveGroup” attribute. Both element types have an “Ident” attribute and a “Size” attribute. The “Ident” attribute must be unique among other partitions within the drive configuration. Size is the size of the partition in bytes to create where a size of 0 indicates all remaining space on the drive.

The “Arrays” section contains “Array” elements. Array elements have “Ident” and “RaidType” attributes, and contain “Segment” elements. Segment elements define the parts that are to make up the array. Segments have a single “Partition”, “PartitionGroup”, or “Array” attribute. If the segment has an array attribute, the array must be defined in a previous “Array” element in the file.

The “Volumes” section contains “Volume” elements. Volume elements have “Array”, “Size”, “FileSystem”, and “MountPoint” attributes. Multiple volumes can identify a single array provided the size attributes allow the volumes to fit on the array. The file system attribute identifies by name the EVMS plugin that will be used to create the file system. Mount point is the mount point for the volume on the SOHO file system.

When drive manager determines the configuration to create it reads the configuration and processes it in order. Drive slots are verified and drive groups are determined. Partition and partition groups are verified and created. Arrays are created in the order they appear. Volumes are created and mounted. If drive manager cannot determine a default configuration from the map, or something in the file is invalid, or something fails during creation, drive manager aborts. In such a case it then destroys any objects it may have created and cleans the drives, and then builds a RAID 5 array consisting of all the drives in the system.

In at least one implementation, drive manager does not handle more than a single RAID5 array, or a single RAID1 array layered on 2 RAID0 arrays, and it also does not handle multiple volumes. However, other implementations of drive manager handle multiple array configurations and multiple volumes per array. Further implementations of drive manager accept commands to configure the drives in various ways, write the current configuration to be a default configuration, and read and export the current/default configuration.

Other embodiments are within the scope of the following claims. For example, other embodiments may allow automatic detection and suggestion of which user selection option would be best for the specified environment.

What is claimed is:

1. A method for use in provisioning storage, the method comprising:
by a user interface hosted at a storage system, allowing a user to affect a set of storage system configuration settings residing on the storage system, the set of storage system configuration settings having options for different levels of redundant array of independent disks (RAID) data protection;
based on the set of storage system configuration settings, configuring the storage system for RAID data protection.

2. The method of claim 1, wherein the set of storage system configuration settings is based on a defined set of XML procedure files.

3. The method of claim 1, further comprising:
basing the configuring of the storage system for RAID data protection on a configurable policy file.

4. The method of claim 1, further comprising:
creating the appropriate file system; and
making the storage accessible from a network attached computer.

5. The method of claim 1, further comprising:
making the user interface accessible by a computer running a Web browser.

6. The method of claim 1, further comprising:
driving a storage controller based on the contents of the storage system configuration settings.

7. The method of claim 1, further comprising:
by the user interface, displaying several different configuration options and general descriptions for those options.

8. The method of claim 1, further comprising:
by the user interface, allowing the user to read the descriptions of the configurations and choose an option.

9. The method of claim 1, further comprising:
allowing the user to choose between multiple pre-configured systems based on a usage description.
